(19) United States
(12) Patent Application Publication
(10) Pub. No.: US 2026/0021610 A1
(43) Pub. Date: Jan. 22, 2026

(54) System for reducing the regeneration consumption of a dehumidifier

(71) Applicant: MST Engineering dell'Ing. Francesco Marzaro, Caltana di Santa Maria di Sala (VE) (IT)

(72) Inventor: Francesco Marzaro, Caltana di Santa Maria di Sala (VE) (IT)

(21) Appl. No.: 18/847,238

(22) PCT Filed: Mar. 14, 2023
(86) PCT No.: PCT/IB2023/052440

§ 371 Date: Sep. 14, 2024

(30) Foreign Application Priority Data
Mar. 14, 2022 (IT) 102022000004928

(51) Int. Cl. B29B 13/06

(52) U.S. Cl. CPC B29B 13/06

(57) ABSTRACT

Raw material processing equipment provided with a dehumidification system for a fluid includes a dehumidifier; an inlet line configured to convey a regeneration fluid into the dehumidifier; a raw material processing machine having an air-conditioned chamber from which a fluid having predetermined thermodynamic parameters is discharged; and a raw material dehumidification/drying system having a dehumidifier/dryer and a return line configured to convey a process fluid toward the dehumidifier/dryer. The inlet line for the regeneration fluid is directly or indirectly connected to a discharge line to discharge the fluid from the air-conditioned chamber and/or to the return line for the process fluid.

### FIELD OF THE INVENTION

The present patent concerns systems for dehumidifying/drying and using plastic materials with regeneration systems for the dehumidifiers, and in particular it concerns a new system for dehumidifying/drying and using plastic materials with an innovative system for reducing the regeneration consumption of an adsorption dehumidifier.

The subject of the present invention is a regeneration system for an adsorption dehumidifier integrated into a system for dehumidifying/drying and using plastic materials.

In particular, the invention which is the subject of the present patent application concerns a system for drawing and distributing the regeneration fluid in a dehumidifier that, by way of non-limiting example, is used for dehumidifying rooms.

The proposed system is therefore generally suited to be applied to those processes in which a fluid with low dew point and temperature T° values is used such as, by way of non-exclusive example, DP<5° C. and generally temperatures T°<25° C., and more specifically to dehumidification systems used for air conditioning or to plastic material processing equipment.

### BACKGROUND OF THE INVENTION

As is known, plastic material in the form of granules or flakes is transformed into finished or semi-finished objects through heating, melting, molding or extrusion processes.

As is known, plastic materials, due to their hygroscopicity, contain water molecules; during the melting processes, water molecules can negatively affect the polymeric structure of the plastic materials themselves, causing surface or structural defects in the finished or semi-finished products, and thus negatively affecting the quality of the end product.

Consequently, in the processing of plastic materials, in order to avoid the formation of bubbles and cavities in the plastic material and any changes in its chemical structure, it is necessary and essential to control the temperature and humidity in the mass of granules, and thus the heating and dehumidification steps.

At present, to extract moisture from plastic materials, these are treated with various drying fluids.

In the dehumidification systems currently used, a certain quantity of plastic material to be dehumidified is therefore introduced into a hopper, in which the material is subjected to the action of the drying fluid heated to a suitable temperature, called process fluid, which heats the material and removes the moisture contained therein.

Once the material has reached the required temperature and humidity conditions, it is conveyed to the processing machine, which completes the process by melting it and injecting it into special molds.

The description of a typical PET transformation process is provided here below by way of example.

Therefore, a processing machine is used for the production of plastic products, wherein said processing machine, by means of a screw, called extruder, melts the plastic granules and injects them into a special mold through suitable channels.

The inside of the mold is equipped with both hot channels, designed to facilitate the flow of the molten material, and cooling zones, designed to quickly harden the molten material into a solid product that can be extracted from the mold.

The mold is generally cooled by means of cold water at temperatures generally included between 5° C. and 15° C.

Processing machines are generally configured in 2 main zones:
1) screw/extruder
2) molding compartment.

Especially in hot and humid climates, the temperatures of the components placed inside the molding compartment can drop below the dew point of the ambient air.

This results in the formation of surface condensation which causes quality problems in the manufactured goods, corrosion, etc.

In order to avoid the formation of condensation inside the molding compartment, it is necessary to compartmentalize and condition the volume in question.

The conditioning of the volume in question can be performed in various ways and with various technologies, however two reference technologies are generally used:
1) machines with refrigeration cycle;
2) adsorption equipment.

This equipment generates an air flow that pressurizes/conditions the molding compartment, thus preventing the formation of condensation inside it.
1) In the case of machines with refrigeration cycle, it is possible to obtain air conditioning flows with dew points >0° C. (usually +3/+5° C.).
2) In the case of adsorption equipment, it is possible to obtain air conditioning flows with dew points even <−10° C., but with significantly higher energy consumption.

This is due to the fact that adsorption equipment needs a hot regeneration flow at temperatures typically included between 80° C. and 130° C., which is usually obtained by means of electric heaters.

The present patent application concerns case 2, that is, adsorption equipment that can use silica gel as adsorbent material, without however excluding other substances suitable for water adsorption that can guarantee similar overall performance of the equipment (alumina, molecular sieves, etc).

In the case at hand, according to the known art, adsorption systems consisting of honeycomb rotors impregnated with an adsorbent material (silica gel, alumina, etc.) are generally used for these applications, without however excluding systems having a different configuration but the same purpose and analogous operating parameters.

In these examples, for simplicity's sake, we will focus on rotor systems, as they are the most widespread, and it can be noticed that said rotors (FIG. 1) generally operate at a constant speed with one part (P) involved in the dehumidification process and one part involved in the regeneration process (R).

The configurations of the process/regeneration flows vary depending on the fields of application; for simplicity's sake, the present patent application makes reference to the basic configuration, in which two separate flows Qp and Qr are used in the dehumidification process and in the regeneration process carried out by the absorber, without however excluding different configurations.

Thanks to said air-conditioning equipment, it is therefore possible to create an environment with low humidity values inside the molding compartments, with dew points generally included between +5° C. and −10° C., in such a way as to avoid condensation phenomena even in critical environmental conditions.

Unlike tower dryers, which are generally constituted by two or more adsorbent towers, some of which operate in the dehumidification process while others operate in the regeneration process, in the case of rotor dryers the equipment operates in a continuous cycle without flow exchange valves and the dehumidification and regeneration flows are generally constant.

Therefore, for simplicity's sake, the description of the invention provided below refers to rotor dryers, as they are widespread and based on a simple construction concept, without however excluding other configurations of the dehumidifier.

The rotor is divided into two portions: the part of the rotor that is active in the process receives a flow of air, usually previously filtered and cooled, which is dehumidified to achieve the final values indicated above.

The part of the rotor that is active in the regeneration, on the other hand, receives a hot flow that can extract the moisture (stripping) previously adsorbed by the rotor during the process phase.

This flow generally works against the current, which however does not exclude different conditions depending on the application.

The lower the process temperature, the greater the amount of water that can be fixed in the adsorbent material.

The higher the regeneration temperature, within the limits allowed by the materials, and the lower the moisture content in the rotor, the greater the amount of water that can be extracted from the rotor.

In practice, at the same temperature, as is understandable, regenerating with dry air is more efficient than regenerating with humid air.

As a result, especially in humid climates, where the ambient air used for regeneration is particularly full of water, the operating conditions are particularly demanding, with significant energy consumption.

Table 1 shows the water content (in g/m³ of dry air) as a function of relative humidity for two reference temperatures.

TABLE 1

| | RH | | | | | | | |
|---|---|---|---|---|---|---|---|---|
| T | 30% | 40% | 50% | 60% | 70% | 80% | 90% | 100% |
| 10° C. | 2.82 | 3.75 | 4.69 | 5.63 | 6.57 | 7.51 | 8.45 | 9.39 |
| 20° C. | 5.18 | 6.91 | 8.63 | 10.36 | 12.09 | 13.82 | 15.54 | 17.27 |
| 30° C. | 9.10 | 12.13 | 15.13 | 18.19 | 21.22 | 24.26 | 27.29 | 30.32 |
| 40° C. | 15.31 | 20.42 | 25.52 | 30.62 | 35.73 | 40.83 | 45.93 | 51.04 |

Table 2 shows the typical output moisture content related to the dehumidification process and to the regeneration process under the respective operating conditions.

TABLE 2

| Process/Reg. | ° C. | RH | Dew Point | g/m³ |
|---|---|---|---|---|
| Process out | 30 | 10 | −4.91 | 3.03 |
| Reg. out | 70 | 25 | +41.03 | 49.2 |

It can be deduced that by starting with low humidity levels in regeneration, it is possible to extract more water and obtain better performance or lower consumption for the same performance level.

In humid environments, it is typical to start with ambient air having a dew point included between +15° C./+25° C.

If it were possible to regenerate with less humid air, the process would be more efficient.

In the case of systems for processing plastic materials, for example in the sector of PET preforms, this is possible.

In fact, the processing machine used, for example, for producing PET preforms, is configured with a robot that can extract a considerable number of preforms (48/72/96) from the mold every 10 to 15 seconds and place them on a conveyor belt that distributes them in special containers.

Said robot operates inside the air-conditioned chamber for the reasons explained above.

The preforms are extracted by means of special gripping hands operated by a negative pressure system.

The negative pressure system is served by a vacuum pump that draws in air intermittently every 10 to 15 seconds.

The pump flow rate is usually included between 100 and 300 m³/h.

The air is drawn from inside the air-conditioned chamber and the discharge temperatures are included between 50° C. and 110° C.

The dew point of the air discharged to the outside is therefore that of the air in the air-conditioned chamber, therefore included between +−5° C.

This air, being very hot, is conveyed outside the molding compartment of the processing machine in such a way as to avoid creating, inside the air-conditioned chamber, thermohygrometric conditions that favor the entry of moisture, and generally heats up the operating environment, further worsening the operating conditions.

### SUMMARY OF THE INVENTION

The object of the invention described in this patent application is therefore to optimize the operating conditions of the air-conditioning system of the molding compartment by using regeneration air at more favorable dew points than those of the ambient air typically used in the known art and at higher temperatures than those found in the known art.

### Dew Point of the Regeneration Flow

The following table shows the typical operating conditions in a plastics processing plant during the summer period.

In this case, reference is made to a typical PET preform production plant, without however excluding other applications.

TABLE 1
Typical environmental conditions during the summer

| | | | |
|---|---|---|---|
| Relative humidity | RH | 50.00 | % rh |
| Specific humidity (wet) | Q | 17.44 | g/kg |
| Temperature | T | 35.00 | ° C. |
| Mixing ratio by weight (dry) | R | 17.75 | g/kg |
| Pressure | P | 1013.25 | hPa |
| Partial vapor pressure | E | 28.12 | hPa |
| Wet-bulb temperature | Tw | 26.26 | ° C. |
| Saturated vapor pressure | Ew | 56.23 | hPa |
| Psychrometric difference | T − Tw | 8.74 | ° C. |
| Vapor concentration at saturation | Dvs | 39.53 | g/m³ |
| Dew point | Dp | 23.02 | ° C. |
| Enthalpy | H | 80.69 | kJ/kg |
| Frost point | Fp | 23.02 | ° C. |
| Volume mixing ratio (dry) | Vmr | 28541.8 | ppm |
| Vapor concentration (wet) | Dv | 19.77 | g/m³ |
| Altitude (above sea level) | El | 0.000 | m |

Therefore, in summary, an environment at 35° C. with 50% rh has a water content of 19.77 g/m³ and a dew point of +23° C.

Using mold cooling water at a temperature in the order of 10° C., it is necessary to maintain a dew point <10° C. in the molding compartment, with a sufficient margin to avoid condensation problems.

With adsorption systems, the safety margin in terms of dew point is higher, therefore these systems are generally preferred.

There are also aspects related to the use and maintenance of equipment with refrigerant gases that tend to limit the use of this equipment. In an air-conditioned molding compartment provided with an adsorption dehumidifier according to the known art, we have values similar to those specified below:

TABLE 2
Typical conditions inside the molding compartment

| | | | |
|---|---|---|---|
| Relative humidity | RH | 25.00 | % rh |
| Specific humidity (wet) | Q | 4.87 | g/kg |
| Temperature | T | 25.00 | ° C. |
| Mixing ratio by weight (dry) | R | 4.90 | g/kg |
| Pressure | P | 1013.25 | hPa |
| Partial vapor pressure | E | 7.92 | hPa |
| Wet-bulb temperature | Tw | 13.67 | ° C. |
| Saturated vapor pressure | Ew | 31.67 | hPa |
| Psychrometric difference | T − Tw | 11.33 | ° C. |
| Vapor concentration at saturation | Dvs | 23.01 | g/m³ |
| Dew point | Dp | 3.63 | ° C. |
| Enthalpy | H | 37.59 | kJ/kg |
| Frost point | Fp | 3.63 | ° C. |
| Volume mixing ratio (dry) | Vmr | 7874.95 | ppm |
| Vapor concentration (wet) | Dv | 5.75 | g/m³ |
| Altitude (above sea level) | El | 0.000 | m |

According to the established technique, in a conventional PET processing machine with 48 cavities, this dew point value can be achieved with approximately 1600 m³/h in the dehumidification process and 400 m³/h in the regeneration process.

FIG. 1 shows a typical functional diagram of an adsorption dehumidifier applied to plastics processing plants.

The process flow at the inlet of the adsorber used to condition the processing machines is usually pre-cooled and dehumidified to approximately 8-15° C. saturated, in such a way as to allow the rotor to operate in optimal temperature/humidity conditions.

Said cooling is usually carried out with the same water used to cool the mold of the processing machine.

Consequently, in the process flow at the inlet of the adsorbent rotor, the thermo-hygrometric conditions typically recorded in the established technique can be the following.

TABLE 3
Typical conditions at the inlet of the adsorber

| | | | |
|---|---|---|---|
| Relative humidity | RH | 100.00% | rh |
| Specific humidity (wet) | Q | 10.53 | g/kg |
| Temperature | T | 15.00 | ° C. |
| Mixing ratio by weight (dry) | R | 10.64 | g/kg |
| Pressure | P | 1013.25 | hPa |
| Partial vapor pressure | E | 17.04 | hPa |
| Wet-bulb temperature | Tw | 15.00 | ° C. |
| Saturated vapor pressure | Ew | 17.04 | hPa |
| Psychrometric difference | T − Tw | 0.000 | ° C. |
| Vapor concentration at saturation | Dvs | 12.81 | g/m³ |
| Dew point | Dp | 15.00 | ° C. |
| Enthalpy | H | 41.96 | kJ/kg |
| Frost point | Fp | 15.00 | ° C. |
| Volume mixing ratio (dry) | Vmr | 17105.6 | ppm |
| Vapor concentration (wet) | Dv | 12.81 | g/m³ |
| Altitude (above sea level) | E | 10,000 | m |

The process flow entering the rotor is generally saturated with water and at temperatures that are low enough to favor adsorption.

Based on the initial process conditions shown in Table 2 and on the final process conditions shown in Table 3, it is possible to calculate the amount of water extracted by the adsorber, which is equal to:

$${H}_{2} O = ( 12.81 - 5.75 ) * 1600 = 7.06 * 1600 = 11296 \text{g/h}$$

Once the amount adsorbed in the dehumidification process has been calculated, the same amount is desorbed in the regeneration process under equilibrium conditions.

Thus, 11296 kg/h of water to be extracted.

The flow rate Qr in the regeneration process assumed for this non-binding example be, according to the established technique, approximately 25% of the flow rate in the dehumidification process.

$$QP = 1600 {m}^{3} \text{/h} . \\ QR = 1600 / 4 = 400 {m}^{3} \text{/h}$$

From Table 1, the inlet air temperature and humidity before regeneration be:

$$T = 35 ° C . \\ RH = 50 PERCENT$$

Therefore, the water content after regeneration using said conditions will be:

$$Dvr = 19.77 + 11 \; 296 / 400 = 19.77 + 28.24 = 48.01 {\text{g/m}}^{3}$$

It is possible to recalculate the thermo-hygrometric conditions of the air flow Qr after regeneration, which are shown in Table 4 below.

Under these conditions, the temperature after regeneration is approximately 70° C. and the relative humidity is approximately 25%.

These conditions are those generally encountered under the typical operating conditions known in the art.

TABLE 4
Typical conditions of the regeneration output flow

| | | | |
|---|---|---|---|
| Relative humidity | RH | 25.00% | rh |
| Specific humidity (wet) | Q | 49.27 | g/kg |
| Temperature | T | 70.00 | ° C. |
| Mixing ratio by weight (dry) | R | 51.82 | g/kg |
| Pressure | P | 1013.25 | hPa |
| Partial vapor pressure | E | 77.93 | hPa |
| Wet-bulb temperature | Tw | 44.93 | ° C. |
| Saturated vapor pressure | Ew | 311.72 | hPa |
| Psychrometric difference | T − Tw | 25.07 | ° C. |
| Vapor concentration at saturation | Dvs | 196.79 | g/m³ |
| Dew point | Dp | 41.03 | ° C. |
| Enthalpy | H | 206.57 | kJ/kg |
| Frost point | Fp | 41.03 | ° C. |
| Volume mixing ratio (dry) | Vmr | 83318.5 | ppm |
| Vapor concentration (wet) | Dv | 49.20 | g/m³ |
| Altitude (above sea level) | E | 10,000 | m |

With the same operating parameters, stable conditions in terms of temperature and humidity after regeneration ensure stable conditions also after dehumidification.

Therefore, the same conditions after regeneration be assumed:

$$Dv = 48.01 {\text{g/m}}^{3}$$

A different moisture content before regeneration be now assumed, as dehumidified air

from the air-conditioned chamber is used.

The same amount of H₂O extracted from the rotor be transported by the outgoing flow:

$$Water = 11.296 kg$$

This quantity must be added to the initial humidity of the regeneration air.

The regeneration flow rate that guarantees the assigned humidity value in g/m³ is then calculated here below.

$$Dv = 5.75 + 11 \; 296 / QR = 48.01 \text{=>} QR = 11296 / ( 48.01 - 5.75 ) \\ QR = 267.3 {m}^{3} \text{/h}$$

Starting from a lower moisture content, the regeneration flow has a higher water capacity, so a lower volume flow rate is sufficient to contain the same amount of water leaving the rotor.

As a result, equilibrium conditions are guaranteed, with the same thermo-hygrometric conditions after regeneration, with a reduction in the regeneration flow rate from 400 to 270 m³/h.

Therefore, under the assigned conditions, the energy saving that can be achieved through the use of drier air for regeneration is approximately 30% (270/400).

### Regeneration Temperature

The typical regeneration temperature of silica gel absorbers in the known art is around 130° C.

Generally, regeneration air is taken from the surrounding environment at average temperatures in the order of 35° C.

In the case of a dehumidification flow rate of 1600 m³/h, a regeneration flow rate in the order of 400 m³/h is generally used.

The required power rating is: M*Cp*Dt=

$$400 * 1.2 * 0.24 * 95 / 860 = 12.73 kW$$

Using the air coming out of the vacuum pump operating the robot inside the moulding compartment, this value can be increased up to an average value of approximately 70° C.

In this case, the required regeneration power becomes:

$$400 * 1.2 * 0.24 * 60 / 860 = 8.04 kW$$

The corresponding energy saving is the following:

$$12 \text{.73} - 8.04 = 4.69 kW = - 37 \% .$$

Since in the proposed solution the air used also has a higher temperature, as specified above, the temperature drop is lower than the temperature drop that occurs in the known art.

As a result, the achievable energy saving (%) under the same operating conditions can be calculated as follows:

$$RE = 1 - ( 270 / 400 * 60 / 95 ) = 57 \% .$$

It is therefore reasonable to state that, thanks to the adoption of the solution described herein and under conditions that are commonly verified in the known art, the energy consumption for the regeneration of a dehumidifier used for the air-conditioning of plastic molding compartments can reach an indicative value of 50% compared to that typically recorded.

With reference to the figures, it should be considered that in general the flow F3/F21 exiting the air-conditioned chamber is not constant over time, in terms of both flow rate and temperature.

As a consequence, it is therefore necessary, at the same time, to provide a compensation system capable of compensating for variations in the flow rate of the flow F21 with a complementary flow F22, F23.

To achieve this, a compensation element (50) is therefore provided, inside which the flows (F21, F22, F23) are mixed.

At the same time, it is necessary to provide, if possible, a heat recovery system suited to raise the temperature of said complementary flow F22, F23 as much as possible to values similar to those of F21, or to heat the flows, if necessary, especially when dispersion in the flow F22 is such that its temperature is significantly reduced.

In the case where the distance between the processing machine and the dehumidifier is such as to cause temperature losses in the air used for regeneration, it is possible to recover part of the available heat back to the dryer that dehumidifies the material used by the processing machine.

In the known art, the temperatures of the fluids returning to the dryer are included between 70° C. and 120° C., depending on the operating conditions, therefore in the considered system said heat recovery is possible.

The invention is a system for reducing the regeneration consumption of a dehumidifier.

We refer, for example, to a dehumidifier in the form of a rotor but the same inventive concept can be repeated for any other type of dehumidifier where there is an inflowing fluid to be dehumidified and a regeneration fluid flow suited to extract the moisture from the dehumidifier.

The system thus comprises:
at least one dehumidifier;
at least one inlet line suited to convey a fluid to be dehumidified into the dehumidifier;
at least one outlet line suited to convey the dehumidified fluid out of the dehumidifier;
at least one inlet line suited to convey a regeneration fluid into the dehumidifier;
at least one outlet line suited to convey the regeneration fluid loaded with the moisture extracted from the dehumidifier out of the dehumidifier;
at least one raw material processing machine provided with at least one air-conditioned chamber containing a fluid having certain characteristics and thermodynamic parameters;
at least one discharge line suited to discharge said fluid contained in said at least one air-conditioned chamber.

According to the invention, the system can also comprise at least one raw material dehumidification/drying system, equipped with at least one dehumidifier/dryer and at least one return line for a process fluid coming from said dehumidification/drying system, wherein said process fluid has certain characteristics and thermodynamic parameters.

According to the invention, said inlet line of said regeneration fluid can be directly and/or indirectly connected to:
said fluid return line from said at least one air-conditioned chamber and/or
said discharge line suited to discharge said process fluid of the dehumidification/drying system,
in such a way that the thermodynamic parameters of at least part of said regeneration fluid are influenced by the thermodynamic parameters of said fluid of the air-conditioned chamber and/or of said process fluid.

In particular, in a first possible solution, said inlet line communicates with said discharge line suited to discharge the fluid from said at least one air-conditioned chamber, in such a manner that said regeneration fluid comprises at least part of said fluid of said at least one air-conditioned chamber.

For example, a certain flow rate of said fluid of said air-conditioned chamber can be withdrawn and fed into said inlet line conveying the regeneration fluid into the dehumidifier.

In a second solution, said inlet line communicates with said return line of said process fluid of the dehumidification/drying system through at least one exchanger, so that at least part of the regeneration fluid entering the dehumidifier is preheated by said process fluid returning to the dehumidifier/dryer.

According to a further possible solution, the regeneration fluid entering the dehumidifier, at least part of which is constituted by said fluid withdrawn from the air-conditioned chamber, is preheated before entering the dehumidifier through heat exchange with said process fluid returning into said dehumidifier/dryer.

By way of non-limiting example, according to the invention one or more exchangers of the air/air type can be used for the heat exchange between said process fluid returning into the dehumidifier/dryer and at least part of said regeneration fluid.

According to the invention, as an alternative to or in combination with the above, an exchanger system of the air/water/air type can be used between the process fluid returning into said dehumidifier/dryer and at least part of said regeneration fluid, taking advantage of the fact that at least one air/water exchanger is generally already present in the dryers used for the dehumidification of plastic materials.

### BRIEF DESCRIPTION OF THE DRAWINGS

The technical characteristics of the invention, according to the above-mentioned purposes, can be found in the claims and their advantages are highlighted in the detailed description provided below, which makes reference to the attached drawings illustrating one or more embodiments by way of non-limiting example, wherein:

FIG. 1 shows an operating diagram of a rotor dehumidifier;

FIG. 2 shows a diagram of a system according to the known art;

FIG. 3 shows a diagram of a system according to a first solution, where the regeneration fluid (F2) is a mixture of a first flow (F21) from the discharge line (320) of the air-conditioned chamber (310) and a second flow (F22) from an exchanger system (430) with the process fluid (F4) returning into a dehumidifier/dryer (410).

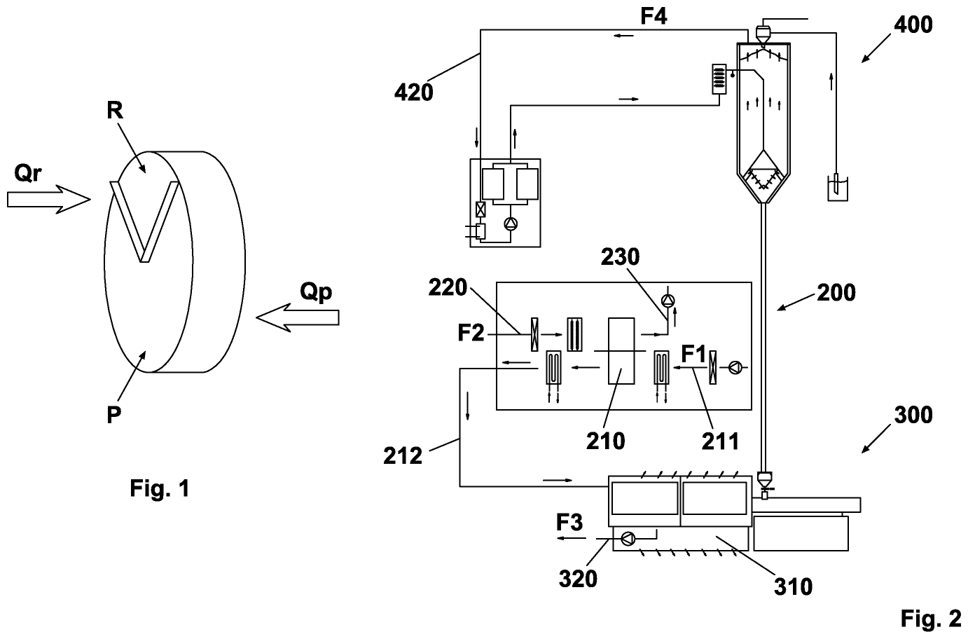

### DETAILED DESCRIPTION OF EMBODIMENTS OF THE INVENTION

Said exchanger system (430) is, for example, of the air/water/air type, using the exchanger (4301) already normally present in the dryers (440).

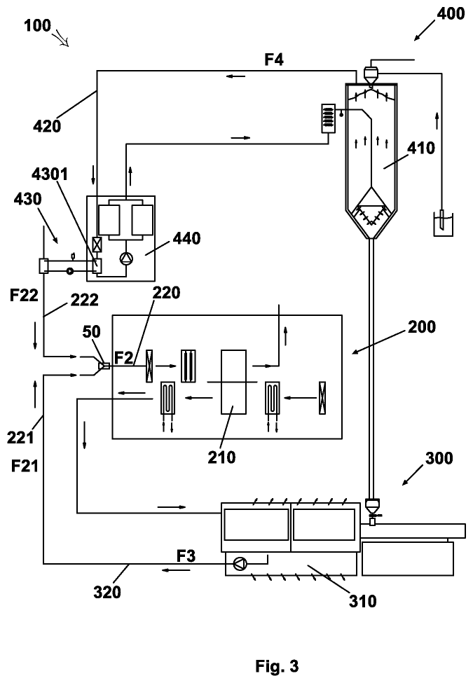

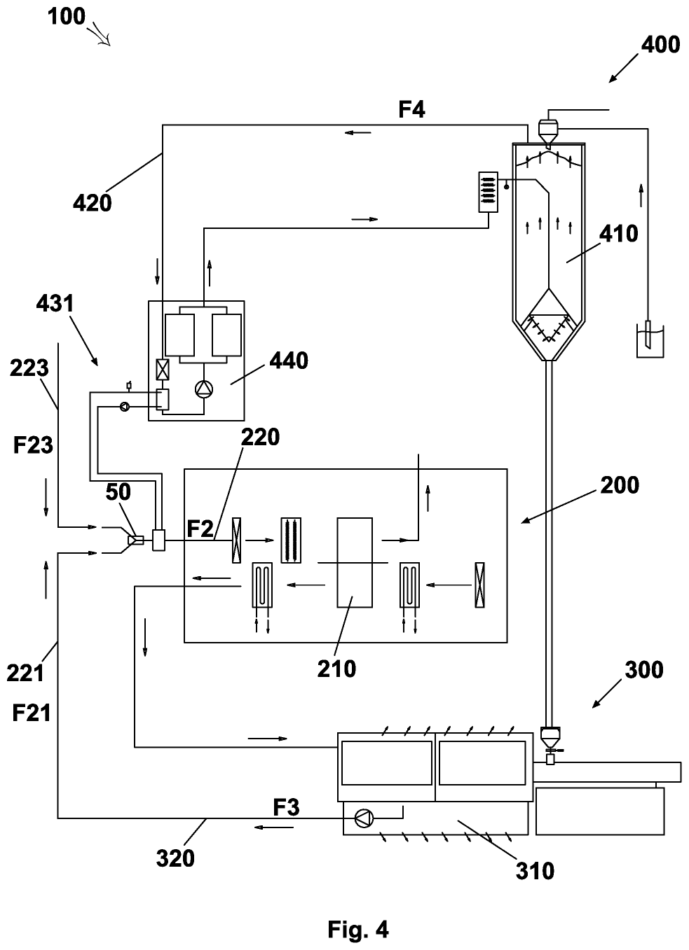

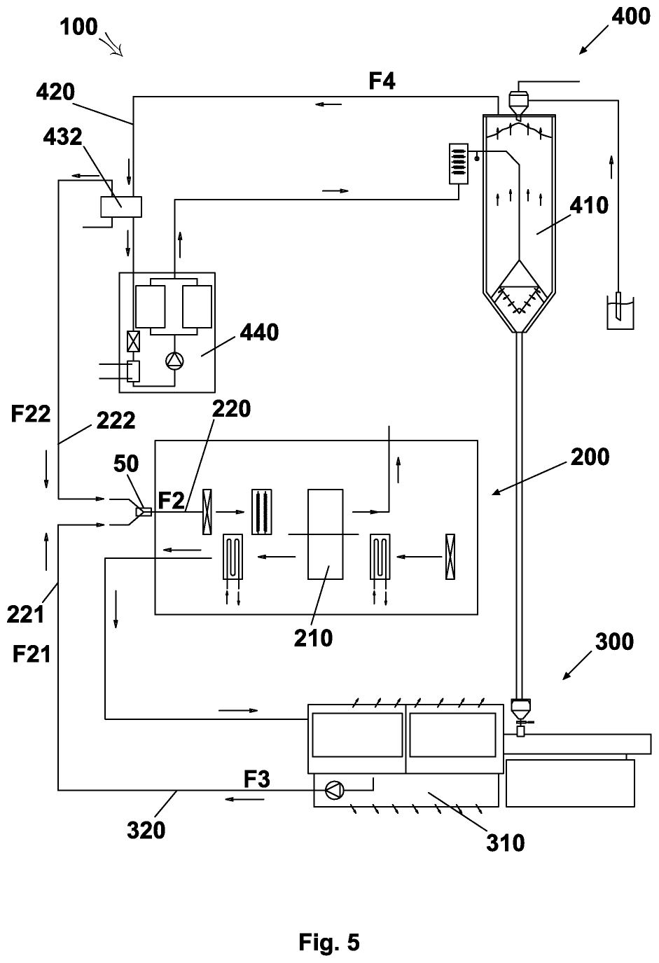

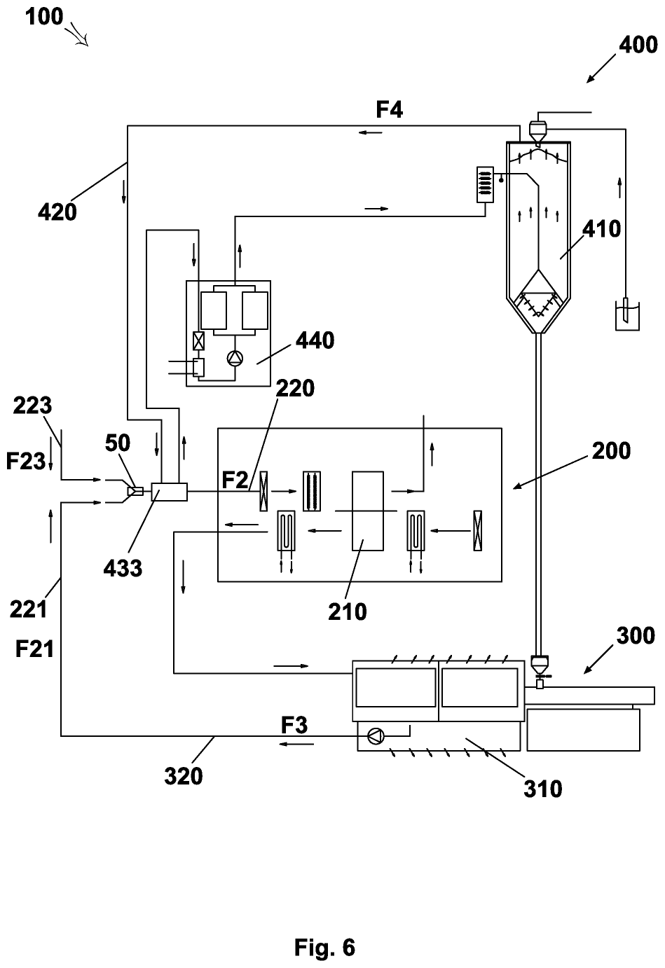

FIG. 3 also shows how the equipment (100), in any of its embodiments, can also comprise one or more compensation/mixing chambers (50), in any case placed upstream of the inlet of said regeneration fluid (F2) into the dehumidifier (210), which are suited to mix the flows. Said chamber is particularly useful in the case where one or more of the flows (F21, F22, F23) constituting the regeneration fluid (F2) is/are not constant, as is the case, for example, for the discharge flow (F3) from the air-conditioned chamber (310).

FIG. 4 shows a diagram of the equipment according to another embodiment, in which the exchanger system (431) processes the entire regeneration fluid flow (F2).

FIG. 5, instead, shows an exchanger (432) of the air/air type, which processes only a portion (F22) of the regeneration fluid (F2).

FIG. 6 shows a diagram of the equipment according to another embodiment, in which the exchanger (433), for example, is of the air/air type and carries out the exchange between the process fluid (F4) returning into the dehumidifier/dryer (400) and the entire regeneration fluid flow (F2).

In the figures, the equipment (100) comprises:
at least one dehumidification system (200) with at least one dehumidifier (210);
at least one inlet line (211) suited to convey a fluid to be dehumidified (F1) into the dehumidifier (210);
at least one outlet line (212) suited to convey the dehumidified fluid out of the dehumidifier (210);
at least one inlet line (220) suited to convey a regeneration fluid (F2) into the dehumidifier (210);
at least one outlet line (230) suited to convey the regeneration fluid full of moisture extracted from the dehumidifier (210) out of the dehumidifier (210);
at least one raw material processing machine (300) equipped with at least one air-conditioned chamber (310) from which a fluid (F3) with certain thermodynamic parameters is discharged;
at least one discharge line (320) for said fluid (F3) discharged from said at least one air-conditioned chamber (310);
at least one raw material dehumidification/drying system (400) with at least one dehumidifier/dryer (410) and at least one return line (420) for a process fluid (F4) returning into said dehumidifier/dryer (410), where said process fluid (F4) has certain thermodynamic parameters.

At least part of said regeneration fluid (F2) is constituted by said fluid (F3) discharged from the air-conditioned chamber (310) and/or is the result of a direct or indirect heat exchange with said process fluid (F4) returning into said dehumidifier/dryer.

In the first solution shown in FIG. 3, the regeneration fluid (F2) is a mixture of a first flow (F21) circulating in a line (221) communicating with the discharge line (320) of the air-conditioned chamber (310) and a second flow (F22) circulating in a line (222) originating from an exchanger system (430) that exchanges heat with the process fluid (F4) returning into a dehumidifier/dryer (410).

In the solution shown in FIG. 4, the exchanger system (431) is positioned upstream of the regeneration towers (440) and upstream of said dehumidifier (210) and processes the entire flow of regeneration fluid (F2).

In the solution shown in FIG. 5, instead, a part (F22) of the entire flow of regeneration fluid (F2) exchanges heat with the process fluid (F4) returning into the dehumidifier/dryer (410), for example in an air/air exchanger (432).

In the solution shown in FIG. 6, the exchanger (433) exchanges heat between the process fluid (F4) returning into the dehumidifier/dryer (410) and the entire flow of regeneration fluid (F2).

Said regeneration fluid (F2) can also comprise at least a portion of flow (F23) from a line (223) having any origin.

Furthermore, the equipment (100), in any of the described solutions, can comprise valves or bypass valves suited to selectively open/close or exclude one or more of said lines (221, 222, 223) conveying fluid (F21, F22, F23) in said inlet line (220) of the dehumidifier (210) and/or in one or more of said exchangers (430, 431, 432, 433) depending on the flow rates and thermodynamic parameters of the regeneration fluid (F2), the process fluid (F4) returning into said dehumidifier/dryer (400) and/or of said fluid (F3) discharged from said air-conditioned chamber (310).

Therefore, with reference to the above description and the attached drawings, the following claims are made.

1. Raw material processing equipment (100) provided with at least one dehumidification system (200) for a fluid (F1), comprising:
a dehumidifier (210);
a first inlet line (211) configured to convey a fluid to be dehumidified (F1) into the dehumidifier (210);
a first outlet line (212) configured to convey the dehumidified fluid out of the dehumidifier (210);
a second inlet line (220) configured to convey a regeneration fluid (F2) into the dehumidifier (210);
a second outlet line (230) configured to convey the regeneration fluid loaded with moisture extracted from the dehumidifier (210) out of the dehumidifier (210);
a raw material processing machine (300) provided with air-conditioned chamber (310) from which a third fluid (F3) having specific thermodynamic parameters is discharged;
a discharge line (320) configured suited to discharge said third fluid (F3) discharged from said air-conditioned chamber (310); and
a raw material dehumidification/drying system (400), with a dehumidifier/dryer (410) and a return line (420) for a process fluid (F4) towards said dehumidifier/dryer (410), wherein said process fluid (F4) has specific thermodynamic parameters,
wherein said second inlet line (220) for said regeneration fluid (F2) is directly or indirectly connected:
to said discharge line (320) for the third fluid (F3) from said air-conditioned chamber (310),
and/or
to said return line (420) for said process fluid (F4) of the raw material dehumidification/drying system (400),
in such a way that thermodynamic parameters of at least a portion of said regeneration fluid (F2) are affected by the thermodynamic parameters of said third fluid (F3) of the air-conditioned chamber (310) and/or of said process fluid (F4).

2. Equipment (100) according to claim 1, wherein at least a portion (F21) of said regeneration fluid (F2) comprises at least a portion of said third fluid (F3) coming from the discharge line (320) of the air-conditioned chamber (310).

3. Equipment (100) according to claim 1, wherein at least a portion (F22) of said regeneration fluid (F2) comes from an exchanger or exchanger system (430, 431, 432, 433) with said process fluid (F4) returning to said dehumidifier/dryer (410).

4. Equipment (100) according to claim 1, wherein at least a portion of said regeneration fluid (F2) is a mixture of a first flow (F21) coming from the discharge line (320) of the air-conditioned chamber (310) and a second flow (F22) coming from an exchanger or exchanger system (430, 431, 432, 433) with the process fluid (F4) returning to a dehumidifier/dryer (410).

5. Equipment (100) according to claim 4, characterized in that wherein said exchanger or exchanger system (430, 431) comprises at least one air-water exchanger normally present in regeneration towers (440) of said raw material dehumidification/drying system (400).

6. Equipment (100) according to claim 1, wherein said regeneration fluid (F2) is a mixture of a first flow (F21) coming from the discharge line (320) of the air-conditioned chamber (310) and a second flow (F23) having any origin, and wherein at least one exchanger or exchanger system (431) processes an entire flow of the regeneration fluid (F2).

7. Equipment (100) according to claim 1, wherein said regeneration fluid (F2) is a mixture of a first flow (F21) coming from the discharge line (320) of the air-conditioned chamber (310) and a second flow (F22) exchanging heat with the process fluid (F4) coming from the dehumidifier/dryer (410).

8. Equipment (100) according to claim 1, wherein said regeneration fluid (F2) is a mixture of a first flow (F21) coming from the discharge line (320) of the air-conditioned chamber (310) and a second flow (F23) having any origin, and wherein an exchanger (433) is installed upstream of the dehumidifier (210) and exchanges heat between the process fluid (F4) returning to the dehumidifier/dryer (410) and an entire flow of the regeneration fluid (F2).

9. Equipment (100) according to claim 3, further comprising valves or bypass valves for selectively opening/closing or excluding one or more lines (221, 222, 223) configured to convey fluid (F21, F22, F23) to said inlet line (220) leading into the dehumidifier (210) and/or one or more exchangers or exchanger systems (430, 431, 432, 433) according to a flow rate and thermodynamic parameters of said process fluid (F4) and/or said third fluid (F3) and said regeneration fluid (F2).
